(19) United States
(12) Patent Application Publication
(10) Pub. No.: US 2016/0202554 A1
(43) Pub. Date: Jul. 14, 2016

(54) Lighting Device and Display Apparatus

(71) Applicant: SAKAI DISPLAY PRODUCTS CORPORATION, Sakai-shi (JP)

(72) Inventor: Yuki Horiguchi, Sakai-shi (JP)

(21) Appl. No.: 14/913,522

(22) PCT Filed: Aug. 5, 2014
(86) PCT No.: PCT/JP2014/070622

§ 371 Date: Feb. 22, 2016

(30) Foreign Application Priority Data
Aug. 26, 2013 (JP) 2013-174651

(51) Int. Cl. G02F 1/1335; F21K 99/00; F21V 17/02; F21V 3/02

(52) U.S. Cl. CPC G02F 1/133608; F21V 3/02; F21K 9/30; F21V 17/02; G02F 1/133606; F21Y 2101/02

(57) ABSTRACT

A lighting device includes a casing housing a light source and having an opening formed at the casing and an extending part extending outward from a periphery of the opening, a translucent body covering the opening, for diffusing light emitted from the light source to output the light, and a frame body covering the extending part through the translucent body disposed between the frame body and the extending part, the frame body having a rib facing a side surface of the translucent body as well as facing and abutting on the extending part, the rib being configured to be capable of being bent by pressing force applied from the translucent body.

### CROSS-REFERENCE TO RELATED APPLICATIONS

This application is the national phase under 35 U.S.C. §371 of PCT International Application No. PCT/JP2014/070622 which has an

International filing date of Aug. 5, 2014 and designated the United States of America.

### FIELD

The present invention relates to a lighting device, for example, used as a backlight outputting light to a liquid crystal panel (display panel), and to a display apparatus comprising the lighting device.

### BACKGROUND

In recent years, a display apparatus comprising a liquid crystal panel as an image displaying part has been widespread. In such a display apparatus, a backlight (lighting device) is arranged behind the liquid crystal panel, which modulates the light from the backlight while transmitting the light to display an image on the front surface of the liquid crystal panel.

As a backlight, a direct type in which a light source is arranged to face the entire rear surface of the liquid crystal panel, or an edge light type in which a light source is arranged to face the end surface of a light guide plate disposed behind the liquid crystal panel the liquid crystal panel has been employed.

In a direct type backlight, light sources are arranged on the bottom surface of a shallow box-shaped backlight chassis (casing) and the opening of the backlight chassis is covered by a diffusion plate (or optical sheet) with a light diffusing function (see Japanese Patent Application Laid-open Publication No. 2005-276716). The diffusion plate is mounted on the periphery of the opening of the chassis. The protruding part formed on the periphery of the opening serves as a rib that reinforces the chassis.

In the backlight described in Japanese Patent Application Laid-open Publication No. 2005-276716, there is a problem that when the diffusion plate expands due to the heat arising from the light emission of the light source, the diffusion plate is prevented from expanding by the protruding part and is thereby distorted. Such a problem can be dissolved by keeping an interval between the diffusion plate and the protruding part in the backlight for preventing the distortion of the diffusion plate. However, because display apparatuses of late years are made to have slim bezels, it is difficult to keep the enough space for sufficiently accommodating the thermal expansion of the diffusion plate in such display apparatuses.

The present invention is made in consideration of the above-described circumstances. The object of the present invention is to provide a lighting device accommodating the thermal expansion and being fit for a slim bezel, and a display apparatus comprising the lighting device.

### SUMMARY

According to an aspect of the embodiment, a lighting device includes a casing housing a light source and having an opening formed at the casing and an extending part extending outward from a periphery of the opening, a translucent body covering the opening, for diffusing light emitted from the light source to output the light, and a frame body covering the extending part through the translucent body disposed between the frame body and the extending part, the frame body having a rib facing a side surface of the translucent body as well as facing and abutting on the extending part, the rib being configured to be capable of being bent by pressing force applied from the translucent body.

According to an aspect of the embodiment, a display apparatus comprises the lighting device described above, and a display panel arranged to face the translucent body of the lighting device. In the display apparatus, light is outputted from the translucent body to a back surface of the display panel, to display an image on a front surface of the display panel.

Additional objects and advantages of the embodiment will be set forth in part in the description which follows, and in part will be obvious from the description, or may be learned by practice of the invention.

The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

According to an aspect of the embodiment, when the translucent body abuts on the rib due to thermal expansion thereof, the rib is bent to prevent the distortion of the translucent body. Therefore, the lighting device can accommodate the thermal expansion and be fit for a slim bezel.

### BRIEF DESCRIPTION OF DRAWINGS

FIG. 1 is a schematic perspective view illustrating an exterior of a display apparatus according to Embodiment 1.

FIG. 2 is a vertical cross-sectional view along the line II-II in FIG. 1.

FIG. 3 is a vertical cross-sectional view of a diffusion plate undergoing thermal expansion along the line II-II.

FIG. 4 is a perspective view of a cross section in the vicinity of a rib according to Embodiment 2.

FIG. 5 is a perspective view of a cross section in the vicinity of a rib according to Embodiment 3.

### DESCRIPTION OF EMBODIMENTS

The present invention will be described in detail below with reference to the drawings illustrating the embodiments thereof.

### Embodiment 1

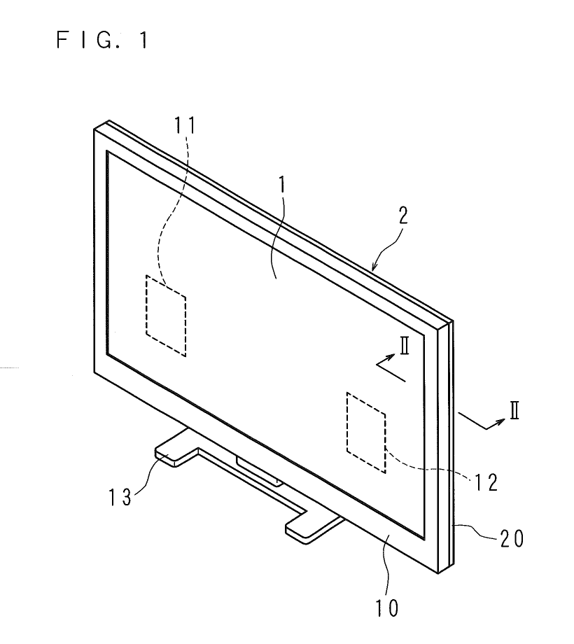

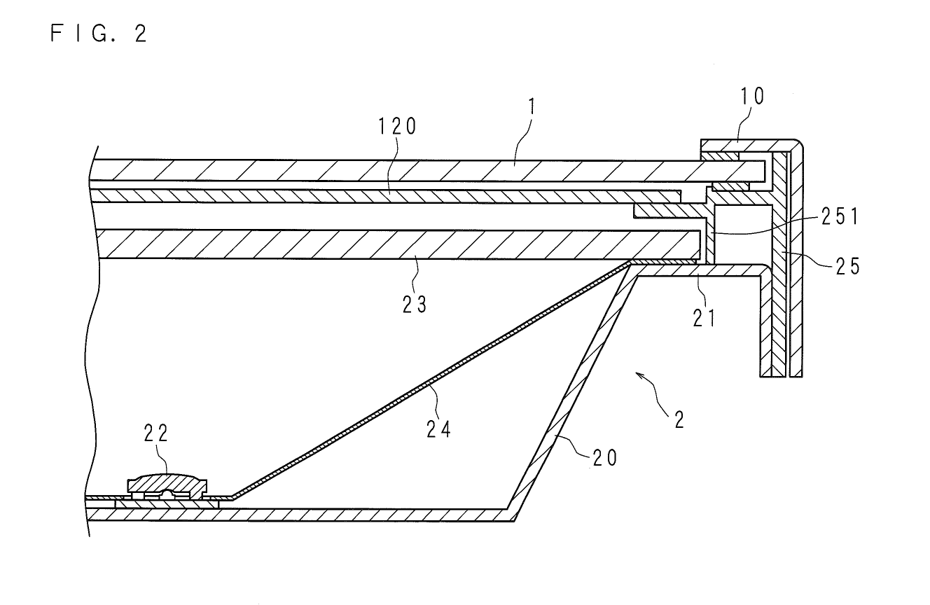

FIG. 1 is a schematic perspective view illustrating an exterior of a display apparatus according to Embodiment 1. FIG. 2 is a vertical cross-sectional view along the line II-II in FIG. 1 and illustrates the upper right side of a backlight 2. The display apparatus illustrated comprises a liquid crystal panel (display panel) 1 that has a rectangular plate shape and is used for displaying an image, and a backlight (lighting device) 2 that outputs light to the liquid crystal panel 1.

A front cabinet 10 having a rectangular frame shape is assembled onto the liquid crystal panel 1 so as to frame the periphery of the front surface (image displaying surface) of the liquid crystal panel 1 for an appropriate width. FIG. 1 illustrates only the image displaying surface of the liquid crystal panel 1 which is exposed inside the frame of the front cabinet 10. The rear surface of the liquid crystal panel 1 is covered by a backlight chassis 20 that is a component of the outer casing of the backlight 2. The backlight chassis 20 is assembled onto the back side of the liquid crystal panel 1 as described below.

The display apparatus illustrated in FIG. 1 is configured as a television receiver that comprises a receiver 11 and a signal processor 12 both of which are assembled onto the back surface of the backlight chassis 20. The receiver 11 is connected to an antenna (not depicted) to receive a television broadcast via the antenna. The signal processor 12 decodes the television broadcast data received by the receiver 11 and separates image data from the decoded data to output the separated image data. The liquid crystal panel 1 displays an image based on the image data output by the signal processor 12 on the image displaying surface.

The display apparatus further comprises a stand 13. The stand 13 has a foot part that is formed to spread in an H shape substantially perpendicular to the leg and connected to the tip of the leg vertically protruding from the center of one longer side of the backlight chassis 20. The display apparatus is supported by the stand 13 on the placement surface to be used while keeping the image displaying surface of the liquid crystal panel 1 in a vertical position. In the following description, the image displaying surface side of the liquid crystal panel 1 is referred to as the front and the other side is referred to as the rear. In addition, the upper and the lower used in the following description correspond to the upper and the lower directions in the state where display device is used as described above, respectively. Likewise, the left and the right correspond to the left and the right seen from the front side while in use.

In the backlight 2 illustrated in FIG. 2, the backlight chassis 20, which is formed in a shallow box shape, houses a plurality of LEDs (light sources) 22 (only one LED 22 is depicted) on the bottom plate thereof in a longitudinal and transverse arrangement. A large number of LEDs 22 are arranged with the same distance from each other on the surface of the bottom plate of the backlight chassis 20. The opening of the backlight chassis 20 is covered by a diffusion plate (translucent body) 23 that is a translucent plate having a larger size than the size of the opening of the backlight chassis 20 and a rectangular shape elongated along the right-left direction. The bottom plate of the backlight chassis 20 is covered with a reflection sheet 24 having high light reflectivity, except for the positions of the plurality of the LEDs 22. The light emitted from each LED 22 is reflected on the reflection sheet 24 to be outputted through the diffusion plate 23 which is held by an extending part 21 extended outward from the periphery of the opening of the backlight chassis 20 and equally diffuses light.

A frame body 25 is a flexible rectangular frame-shaped member made of resin and covers the extending part 21 through the diffusion plate 23 in between. In addition, the frame body 25 has a rib 251 positioned with a distance from a side surface of the diffusion plate 23 while facing and abutting on the extending part 21. As illustrated in the figure, the rib 251 is formed thinner along the mediolateral direction than the other part of the frame body 25 and provided along a length direction of the frame body 25. The rib 251 is configured to be capable of being bent when pressure is applied thereon in the thickness direction.

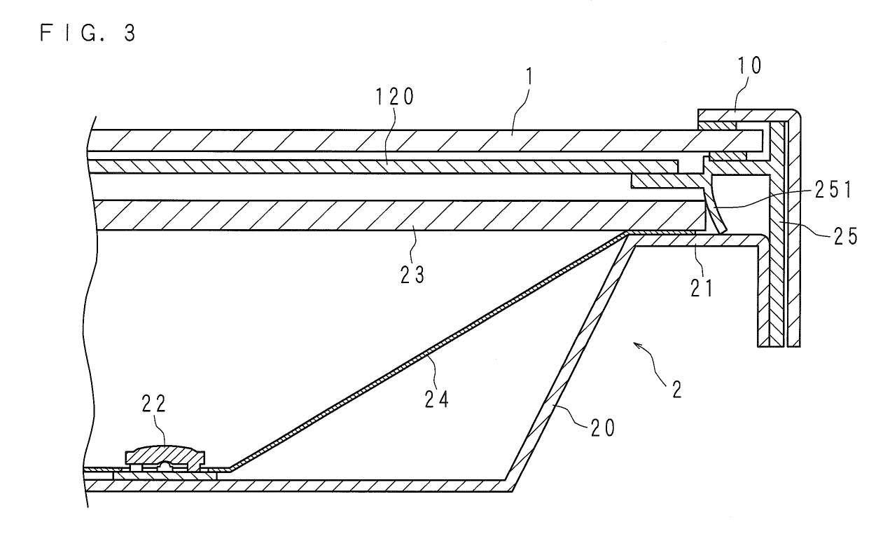

The diffusion plate 23 thermally expands due to the heat arising from the light emission of the LEDs 22. FIG. 3 is a vertical cross-sectional view of a diffusion plate 23 undergoing thermal expansion along the line II-II. As illustrated in FIG. 3, when the diffusion plate 23 thermally expands due to the heat arising from the light emission of the LEDs 22, the diffusion plate 23 expands to the right side to abut on the rib 251 and the abutting diffusion plate 23 presses the rib 251 toward the right side. The pressed rib 251 is bent and deformed toward the right side.

The display apparatus is provided with the above-described backlight 2, an optical sheet 120 mounted on the frame body 25, and the liquid crystal panel 1 that is held between the backlight 2 and the front cabinet 10 arranged to face the diffusion plate 23 of the backlight 2.

While the upper right side of the backlight 2 is illustrated and described in the description above, it should be noted that similar structures are provided in the upper left side, the lower right side and the lower left side of the backlight 2.

As described above, the rib 251 is configured to be capable of being bent when the diffusion plate 23 held on the extending part 21 of the backlight chassis 20 abuts on the rib 251 due to the thermal expansion. Therefore, the backlight 2 can prevent the distortion of the diffusion plate 23 caused by the thermal expansion. The backlight 2 can thus accommodate the thermal expansion and be fit for the slim bezel of the front cabinet 10.

### Embodiment 2

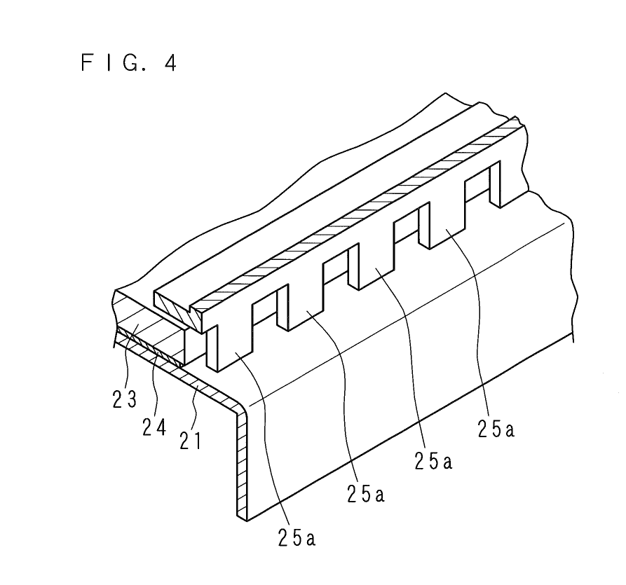

FIG. 4 is a perspective view of a cross section in the vicinity of the rib 251 according to Embodiment 2 and illustrates the upper right side of the backlight 2. The configurations and functions not specifically described below are the same as those according to Embodiment 1, and the description thereof is not provided for simplicity.

The rib 251 is composed of a plurality of rectangular ribs 25a protrudingly formed with a distance between each other along the short-length direction of the frame body 25. The overall shape of the rib 25 is thus a comb shape. The rib 251 is configured to be easily bent because of less restoring force against the pressing force applied from the diffusion plate 23, when the diffusion plate 23 abuts on the rib 251 due to the thermal expansion thereof.

As described above, in Embodiment 2, because the rib 251 is bent by the pressing force applied from the diffusion plate 23 as in Embodiment 1, the interval between the rib 251 and the diffusion plate 23 can be made shorter. Therefore, the backlight 2 can accommodate the thermal expansion and be fit for the slim bezel of the front cabinet 10.

### Embodiment 3

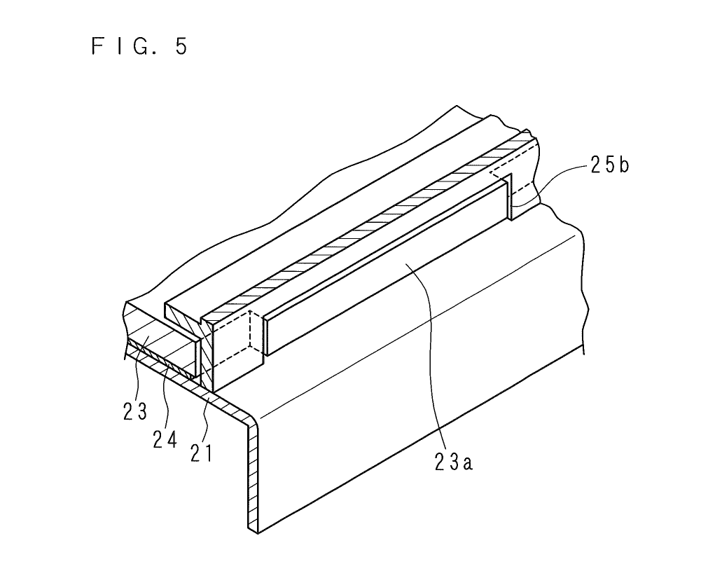

FIG. 5 is a perspective view of a cross section in the vicinity of the rib 251 according to Embodiment 3 and illustrates the upper right side of the backlight 2. The configurations and functions not specifically described below are the same as those according to Embodiment 1 or 2, and the description thereof is not provided for simplicity.

As illustrated in FIG. 5, the rib 251 has a missing part 25b with a rectangular cross section. The diffusion plate 23 has a protruding part 23a with a rectangular cross section protrudingly formed from the right side surface of the diffusion plate 23 along the direction perpendicular to the right side surface and inserted through the missing part 25b.

As described above, in the present embodiment, the protruding part 23a is inserted into the missing part 25b. Therefore, the contact area between the diffusion plate 23 and the extending part 21 of the backlight chassis 20 is enlarged so that the area on which the diffusion plate 23 is stably mounted can further be reserved.

It should be noted that, because the diffusion plate 23 according to the present embodiment has a rectangular shape elongated along the right-left direction, the amounts of thermal expansion are greater at the left side and the right side whereas smaller at the upper side and the lower side. Therefore, the ribs 251 according to the present embodiments may be excluded at the upper side and the lower side of the diffusion plate 23. It should also be noted that the diffusion plate 23 according to the present embodiments may be an acrylic plate or the like with an optical sheet mounted on the front surface thereof.

According to an aspect of the embodiment, a backlight 2, includes the backlight chassis 20 housing the LEDs 22 and having an opening formed at the backlight chassis 20 and an extending part 21 extending outward from a periphery of the opening, the diffusion plate 23 covering the opening, for diffusing light emitted from the LEDs 22 to output the light, and the frame body 25 covering the extending part 21 through the diffusion plate 23 disposed between the frame body 25 and the extending part 21, the frame body 25 having a rib 251 facing a side surface of the diffusion plate 23 as well as facing and abutting on the extending part 21, the rib 251 being configured to be capable of being bent by pressing force applied from the diffusion plate 23.

Therefore, the backlight 2 can accommodate the thermal expansion and be fit for a slim bezel.

According to an aspect of the embodiment, the rib 251 is provided along the length direction of a side of the frame body 25.

According to an aspect of the embodiment, the rib 251 is provided along the length direction of the side of the frame body 25.

The rib 251 is thus configured to be easily bent. Therefore, the backlight 2 can accommodate the thermal expansion and be fit for a slim bezel.

According to an aspect of the embodiment, in the backlight 2, the rib 251 includes the missing part 25b and the diffusion plate 23 has the protruding part 23a inserted into the missing part 25b to protrude to the outside of the rib 251.

According to an aspect of the embodiment, in the backlight 2, the rib 251 includes the missing part 25b. The diffusion plate 23 has the protruding part 23a inserted into the missing part 25b to protrude to the outside of the rib 251.

The contact area between the diffusion plate 23 and the extending part 21 of the backlight chassis 20 is enlarged so that the area on which the diffusion plate 23 is stably mounted can further be reserved.

According to an aspect of the embodiment, in the backlight 2, the frame body 25 has a rectangular frame shape, and a plurality of the ribs 251 are protrudingly formed with a distance between each other along the short-length direction of the frame body 25.

According to an aspect of the embodiment, in the backlight 2, the frame body 25 has the rectangular frame shape. A plurality of the ribs 251 are protrudingly formed with the distance between each other along the short-length direction of the frame body 25.

Thus, because the rib 251 is bent and deformed by the pressing force applied from the diffusion plate 23, the interval between the rib 251 and the diffusion plate 23 can be made shorter. Therefore, the backlight 2 can accommodate the thermal expansion and be fit for the slim bezel of the front cabinet 10.

According to an aspect of the embodiment, the display apparatus comprises the backlight 2 and the display panel 1 arranged to face the diffusion plate 23 of the backlight 2. The light is outputted from the diffusion plate 23 to the back surface of the display panel 1, to display an image on the front surface of the display panel 1.

According to an aspect of the embodiment, the display apparatus comprises the backlight 2 and the display panel 1 arranged to face the diffusion plate 23 of the backlight 2. The light is outputted from the diffusion plate 23 to the back surface of the display panel 1, to display an image on the front surface of the display panel 1.

Therefore, the display apparatus prevents the distortion of a displayed image which would be caused by the thermal expansion of the diffusion plate 23.

It should be understood that the embodiments disclosed herein are illustrative and non-restrictive in every respect. Since the scope of the present invention is defined by the appended claims rather than by the description preceding them, and all changes that fall within metes and bounds of the claims, or equivalence of such metes and bounds thereof are therefore intended to be embraced by the claims

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

1-5. (canceled)

6. A lighting device, comprising:
a casing housing a light source and having an opening formed at the casing and an extending part extending outward from a periphery of the opening,
a translucent body covering the opening, for diffusing light emitted from the light source to output the light, and
a frame body covering the extending part through the translucent body disposed between the frame body and the extending part, the frame body having a rib facing a side surface of the translucent body as well as facing and abutting on the extending part, the rib being configured to be capable of being bent by pressing force applied from the translucent body.

7. The lighting device according to claim 6, wherein the rib is provided along a length direction of a side of the frame body.

8. The lighting device according to claim 7, wherein
the rib includes a missing part, and
the translucent body has a protruding part inserted into the missing part to protrude to an outside of the rib.

9. The lighting device according to claim 6, wherein
the frame body is rectangular frame shaped, and
a plurality of the ribs are protrudingly formed with a distance between each other along a short-length direction of the frame body.

10. A display device, comprising:
the lighting device according to claim 6, and
a display panel arranged to face the translucent body of the lighting device,
wherein light is outputted from the translucent body to a back surface of the display panel to display an image on a front surface of the display panel.
